(19) United States
(12) Patent Application Publication
(10) Pub. No.: US 2006/0245754 A1
(43) Pub. Date: Nov. 2, 2006

(54) Photonic integrated circuit equipped with means for interconnecting with added opto-electronic components

(75) Inventors: Serge Valette, Grenoble (FR); Christophe Martinez, Grenoble (FR)

Correspondence Address: PILLSBURY WINTHROP SHAW PITTMAN, LLP, P.O. BOX 10500, MCLEAN, VA, 22102, US

(73) Assignee: Teem Phonics, Meylan (FR)

(21) Appl. No.: 10/557,042

(22) PCT Filed: May 19, 2004
(86) PCT No.: PCT/FR04/50204

§ 371 Date: Nov. 16, 2005

(30) Foreign Application Priority Data
May 19, 2003 (GB) 03/50157

(51) Int. Cl. H04J 14/00

(52) U.S. Cl. 398/43

(57) ABSTRACT

The invention relates to a photonic integrated circuit including a substrate (1) comprising at least one optical circuit (4) and means for interconnecting (2, 3) the optical circuit with at least one opto-electronic component (6, 8, 9, 11, 12) added on to the substrate. The interconnection means are constituted by at least one zone of the substrate with the refractive index thereof being modified to provide said interconnection. This zone of the substrate includes at least one graded index lens.

### TECHNICAL FIELD

The present invention relates to a photonic integrated circuit equipped with means for interconnecting with added opto-electronic components.

### PRIOR ART

Photonic integrated circuits do not use a single or so-called monolithic technological approach unlike microelectronic integrated circuits. By way of example, in the field of microelectronic integrated circuits in respect of MOS technology on a silicon substrate, the key component constituted by the MOS transistor is duplicated a great number of times in order to build the integrated circuit required. Photonic integrated circuits on the contrary employ individual components that are very different in terms of functionality or geometry and which, more often than not, use varied technologies applied to different substrates. Thus, laser diodes or certain types of optical modulators or amplifiers are made on substrates of InP, very high-frequency electro-optical modulators are made on substrates of lithium niobate, the passive components (power dividers, wavelength multiplexers, etc.) are made on substrates of glass or silicon. The technologies involved in making these components are very different from each other: epitaxy of thin semiconductor layers on InP substrates, titanium diffusion or proton exchanges on lithium niobate substrates, ion exchanges on glass substrates or CVD deposition of layers of silica on silicon substrates.

Furthermore, some components cannot in fact be made in integrated versions. They are made either on optical fibre (spectral filters for example), or in free space micro-optics (light isolators, some interference filters, etc). Moreover, light data transmission uses single-mode, or even multimode, optical fibres, the optical and geometric characteristics of which are more often than not different from those of the integrated circuits mentioned.

This strongly hybrid character of opto-electronics involves the employment of sophisticated connection techniques that are awkward to control (the use of micro-lenses and the need for extremely accurate alignment, etc). These techniques are highly disadvantageous in economic terms.

These problems of connections and optical impedance matching between opto-electronic device elements are highly generic problems that are posed in every field of application of opto-electronics from instrumentation (industrial, medical, scientific, etc) to optical telecommunications. These problems are all the more critical as production cost constraints mount up, which is increasingly the case in optical communications as optical transmissions get closer to the subscriber and as the number of components or optical modules employed grows massively in terms of the number of parts used.

### DISCLOSURE OF THE INVENTION

The invention proposes a photonic integrated circuit that allows the above drawbacks to be overcome.

The subject is therefore a photonic integrated circuit including a substrate comprising at least one optical circuit and means for interconnecting the optical circuit with at least one opto-electronic component added to the substrate, the interconnection means being constituted by at least one zone of said substrate with the refractive index thereof being modified to provide said interconnection, said zone of the substrate including at least one graded index lens.

An opto-electronic component can thus be added to the periphery of the substrate, onto one surface of the substrate or into a cavity in the substrate.

The interconnection between the optical circuit of the photonic integrated circuit and the added opto-electronic component is then achieved by free space optical routing. The invention therefore allows free space (3-D) optical elements and planar (2-D) optical elements to be combined on one and the same integrated circuit.

There are numerous publications mentioning the implementation of planar optical components that allow a generally partial modification of the mode profiles of a planar guide by using adiabatic structure the function of which may be compared to that of a “funnel” for light. More often than not and for reasons related to the use of masks in defining the patterns required in guided wave optics, this type of adaptation is employed in a single dimension defined by the direction perpendicular to the plane of the wave propagation and located in the plane of the substrates used.

Solutions for the implementation of adiabatic structures that allow a mode modification in the two directions perpendicular to the direction of propagation have been proposed but have generally come up against a very significant increase in technological stages, too disadvantageous in terms of manufacturing output to be of real use. Anyway, this type of structure based on the ingenious stacking of layers of different thicknesses preserves in all cases the guided character of the light wave and has never used a transfer from guided wave optics to free space optics (or vice versa) as proposed in the invention.

The optical circuit may particularly be made using an ion exchange technique. The same is true for the substrate zone constituting the interconnection means.

The production, during a fabrication process, of planar and 3-D optical elements is original. Indeed, although it is based on a physical approach, similar to modifying the optical parameters of glass (the exchange between the glass ions and the external ions brought in by adapted salt baths), these two types of elements employ very different technological approaches. The production of the planar components involves masking stages that define the patterns required in the surface plane of the substrates (or of the collective production wafer). The production of the 3-D components, and in particular of the graded index lenses, is based on a symmetrical diffusion of ion species approach starting not from a planar substrate but from bars immersed in adapted salt baths, with no masks being employed. In accordance with the prior art, these two types of elements use substrates of completely different geometries that are not adapted to the implementation of the invention.

These elements can be made by chemical or ion lithography techniques or by irradiation using a laser beam. The ion exchange technique gives greater freedom of parameterisation and seems well adapted to the industrial implementation of the concept of the invention.

The optical circuit may comprise an optical wave guide one end of which is located facing said zone of the substrate so as to make a connection with said zone of the substrate.

Said zone of the substrate may be located in the substrate in such a way as to be facing an input or an output of the opto-electronic component so as to make a connection with said opto-electronic component. It may include at least two graded index lenses the axes of which are offset one relative to the other.

The opto-electronic component may be added to the periphery of the substrate or onto the surface of the substrate. In this latter case, the substrate may be provided with at least one cavity allowing at least one opto-electronic component and/or at least one optical component to be accommodated.

Another subject of the invention is a process for the collective production of photonic integrated circuits as defined above, characterised in that it includes the following steps:
providing a wafer intended to provide as many substrates as there are photonic integrated circuits to implement,
implementing on the wafer interconnection means for each photonic integrated circuit,
implementing on the optical circuit wafer each photonic integrated circuit,
possibly, implementing on the wafer means of accommodating at least one opto-electronic and/or optical component for each photonic integrated circuit,
cutting the wafer to obtain the photonic integrated circuits.

The process may additionally include a step of transferring or adding at least one opto-electronic component and/or at least one optical component to complete the photonic integrated circuits.

The interconnection means can be made using a mask that has a principal aperture that is overall rectangular in shape and adjacent sides connected by a neck moulding. The aperture may have two opposite sides that are convex and/or concave in shape. It may have two opposite sides convex in shape and the two other opposite sides concave in shape. All the sides of the aperture may be convex in shape. They may all be concave in shape. The mask may also have at least one secondary aperture located near to at least one side of the principal aperture.

### BRIEF DESCRIPTION OF THE DRAWINGS

The invention will be better understood and other advantages and particularities will emerge from reading the following description, given as a non-restrictive example, accompanied by the appended drawings wherein:
FIGS. 1A to 1D are views from above of a substrate subjected to stages of fabrication to provide a photonic integrated circuit according to the present invention,
FIGS. 2A to 2C show some stages in the process for the collective production the photonic integrated circuit in FIGS. 1A to 1D,
FIGS. 3 and 4 are partial views from above and from the side respectively of a photonic integrated circuit according to the invention,
FIGS. 5 and 6 are partial views from above and from the side respectively of another photonic integrated circuit according to the invention,
FIG. 7 is a partial view from the side of another photonic integrated circuit according to the invention,
FIG. 8 is a partial view from the side of a further photonic integrated circuit according to the invention,
FIG. 9 is a partial view from the side of a further photonic integrated circuit according to the invention,
FIGS. 10 and 11 give possible embodiment examples of interconnection zones for photonic integrated circuit according to the invention,
FIGS. 12 to 14 give other possible embodiment examples of interconnection zones for photonic integrated circuits according to the invention,
FIG. 15 shows a cylindrical optical element able to provide a lens of circular symmetry,
FIG. 16 shows a refractive index profile shape for the embodiment of an interconnection zone according to the present invention,
FIGS. 17 to 24 show different configurations of possible masks for the implementation of the present invention.

### DETAILED DISCLOSURE OF PARTICULAR EMBODIMENTS

FIGS. 1A to 1D show the concept of the invention in terms of its general nature. They show the principal technological stages leading to the implementation of a photonic integrated circuit according to the invention.

FIG. 1A shows a glass substrate 1 on which have been implemented zones 2 and 3 intended to provide the interconnection between an optical circuit to be implemented on the substrate 1 and opto-electronic components to be added. Generally speaking, the zones 2 and 3 intended for the interconnection are implemented prior to the optical circuit or circuits so as to minimise interactions between the fabrication processes. This is what is shown in FIG. 1A.

FIG. 1A shows interconnection zones 2 located on the periphery of the substrate 1 for connection with electro-optical components, which will be connected to the periphery of the substrate. It also shows interconnection zones 3 located inside the surface of the substrate 1 for the connection of an opto-electronic component to be located at the very core of the substrate 1.

FIG. 1B shows the substrate 1 after the implementation of an optical circuit 4 in relation to interconnection zones 2 and 3 pre-integrated at the previous stage.

FIG. 1C shows that a cavity 5 has been implemented on the substrate 1, between the interconnection zones 3. The cavity 5 has dimensions selected to allow an opto-electronic component to be positioned for connection in the optical circuit 4.

FIG. 1D shows the photonic integrated circuit obtained when the opto-electronic components provided have been transferred to the substrate 1. By way of example, onto the periphery of the substrate 1 have been transferred a semiconductor laser diode 6, a single-mode input optical fibre 7, an integrated optical circuit 8 employing another technology and/or another substrate from the substrate 1, a multimode optical fibre 9, a spectral filter 10 associated with a photo-detector 11. Between the zones 3 and in the cavity 5 has been housed an isolator 12.

The interconnection zones 2 and 3 are obtained by local modification Δnᵢ (x,y) of the refractive index nᵥ of the glass substrate for example by ion exchange techniques.

The value of the profiles Δnᵢ (x,y) and their positioning within or at the periphery of the substrate 1 are adapted to the optical characteristics of the components or elements to be connected on the one hand and of the optical circuit or circuits on the other hand. Strictly speaking, each profile Δnᵢ (x,y) may be different from the others but, for reasons of technical simplicity, it is of course preferable to limit the number of different profiles required and, as far as possible, to play on the respective positionings of the components or elements to optimise the different connections required.

The concept of the invention is compatible with an integrated circuit collective production mode as is shown in FIGS. 2A to 2C.

FIG. 2A shows a glass wafer 100 intended for the fabrication of a plurality of photonic integrated circuits of the type described in FIGS. 1A to 1D. To facilitate understanding, the delimitation of the substrates 1 has been shown. FIG. 1A shows that the interconnection zones 2 and 3 have been produced collectively.

FIG. 2B shows the collective implementation of the optical circuits 4.

FIG. 2C shows the collective implementation of the cavities 5.

At the end of the collective fabrication process, the wafer is cut to provide a plurality of photonic integrated circuits like the one shown in FIG. 1C.

The implementation of the interconnection zones will now be described in greater detail.

FIGS. 3 and 4 are views from above and from the side respectively of a photonic integrated circuit according to the invention.

This integrated circuit is formed on a glass substrate 21. This circuit has an association between a single-mode or multimode optical guide 24 and an integrated interconnection zone 22 placed facing one end of the optical guide 24. The zone 22 is constituted by a graded index lens with parameters pre-calculated to obtain at the integrated circuit output, and in response to a light beam carried by the optical wave guide 24, a collimated light beam 20 of given diameter and of low angular divergence.

FIGS. 5 and 6 are views from above and from the side respectively of another photonic integrated circuit according to the invention.

This integrated circuit is formed on a glass substrate 31. This circuit has an association between a single-mode or multimode optical wave guide 34 and an integrated interconnection zone 32 placed facing one end of the optical wave guide 34. The zone 32 is constituted by a graded index lens with parameters pre-calculated so as to obtain at the integrated circuit output, and in response to a light beam carried by the optical wave guide 34, a light beam 30 refocused at a distance and with refocusing point dimensions that are pre-set so as to form a light guide output image of given position and magnification, this image being able to be real or virtual depending on the type of coupling to be optimised.

The interconnection zones 22 or 32 are defined by conventional lithographic masking processes, as will be described below. In the two previous examples, the light guide is buried underneath the surface of the substrate, at a depth X_{oG} (see FIGS. 4 and 6) and the axis of the graded index lens at a depth X_{oL}. In FIGS. 4 and 6, the depths X_{oG} and X_{oL} have been selected to be equal and the axes of the light beam generated by the graded index lenses remain parallel to the axis of the guide.

It is perfectly possible to select different depths for X_{oG} and X_{oL}. This is shown in FIG. 7. The integrated circuit is formed on a glass substrate 41 and has an association between an optical wave guide 44 and an integrated interconnection zone 42 placed facing one end of the optical guide 44. The zone 42 is constituted by a graded index lens with parameters pre-calculated to obtain at the integrated circuit output, and in response to a light beam carried by the optical wave guide 44, a collimated light beam 40.

In the case shown, the depths X_{oG} and X_{oL} are different. These depths are offset by a value ΔX=X_{oG}−X_{oL} corresponding to an inclination of pre-set angle Δθ directly related to the shift ΔX.

Likewise, in a view from above (in the surface plane of the integrated circuit), these same axes of light beams may be offset by a value ΔY, which leads in this plane to an angular shift Δφ.

Starting from this straightforward configuration where the interconnection zone is constituted by a straightforward graded index lens, it is easy to imagine more complex configurations of integrated optical elements that will allow certain intrinsic limitations to be overcome. One of these limitations may be attained if the particular constraints of optical circuit coupling necessitate for example the implementation of a collimated beam of large diameter, corresponding to required low angular divergence values. Indeed, the depth X_{oG} of the axis of the light guide is more often than not a few μm, or even a few tens of μm, in particular in the guides obtained by ion exchange in lenses which, in practice, will be used to advantage in implementing the invention. The standard depth is of the order of 15 μm although it is possible to exceed this value.

This limitation of the value of X_{oG} brings about a limitation of the accessible diameters in the cross-section plane XOZ in the event of a single lens being used since the maximum value of the diameter cannot exceed 2X_{oG} given the presence of the surface of the integrated circuit. This problem can be overcome in a number of ways.

According to one first solution, the planar guide can be locally buried so as to increase the depth of the object point whose image will be formed by the graded index lens implemented. FIG. 8 shows this solution in the case of a collimated image beam.

In this figure, the integrated circuit is formed on a glass substrate 51 and has an association between an optical wave guide 54 and an integrated interconnection zone 52 placed facing one end of the optical wave guide 54. The optical wave guide 54 is buried at a depth X_{oG} over one part of its length, then at a depth X′_{oG} over another part, closer to the zone 52. In this way, it is possible to obtain, by means of the lens forming the zone 52, a collimated beam 50 of relatively significant diameter.

This solution may have drawbacks given that the burial of the light guides (for example under an electrical field as is known in the ion exchange technique in lenses) is accompanied by modifications of the refractive index profile of the guided wave mode or modes and therefore of the dimensions of the object point under consideration. It is possible to take this effect into account, for example via the optical parameters of the lens. This variant may apply to the case shown in FIG. 7. two lenses

According to the second solution, may be employed with axes offset in the plane XOZ. FIG. 9 shows this solution in the case of a collimated beam.

In this figure, the integrated circuit is formed on a glass substrate 61 and has an association between an optical wave guide 64 and an integrated interconnection zone 62 including a first lens 162 facing one end of the optical wave guide 64 and a second lens 262 facing the output of the first lens 162. The optical wave guide 64 is buried at a depth X_{oG}, the lens 162 at a depth X_{oL1} and the lens 262 at a depth X_{oL2} such that X_{oL2}>X_{oL1}>X_{oG}.

In the situation where the first lens works with a magnification G_{L1} equal to −1, the following relation is obtained:
X_{oL2}=X_{oL1}+(X_{oL1}−X_{oG})=2X_{oL1}−X_{oG}.

For this the light guide output image has only to be formed on the side opposite to its position relative to the axis of the first lens 162. In this case, only the lower part of the lens 162 participates in the light ray deviation and collimation phenomenon. The collimated beam can therefore no longer see the surface of the optical wave guide and the use of a lens 262 that is non-symmetrical relative to its axis (defined by the position of the maximum refractive index for the graded index implemented) and of sufficient extension in depth allows the required limitation of diameter to be avoided for the collimated output beam 60.

The magnification G_{L1} may be selected to be different from −1. It may be equal to −0.5 or −0.25 to mention only a few advantageous examples. The use of a magnification of less than 1 makes it possible for example, for a given diameter value, to shorten the focal length of the lens 262 and therefore the length of this lens working with infinite magnification given the increase in the image numerical aperture the light beam diffracted by the light guide.

FIG. 10 shows a first embodiment example of an interconnection zone for a photonic integrated circuit according to the invention. In this example, the substrate is seen in cross-section along the plane XOZ. The dot and dash line 75 shows the surface of the substrate. The optical wave guide 74 has also been shown with one end facing the interconnection zone 72 constituted by a first lens 172 and by a second lens 272.

A diagram of axes OZ (showing the propagation distance of a light wave) and OX (showing the burial depth) and superposed over the cross-section of the substrate. The origin of the axis OZ is the end of the optical wave guide 74. The origin of the axis OX is the central part of the lens 172. The beam passing through the interconnection zone 72 has the same consideration as for FIG. 9.

The image point given by the first lens 172 coincides with the input surface of the second lens 272. This configuration is only one illustration among many other possible ones which allows a collimated optical beam of given dimension to be obtained from an object point corresponding to the far-field diffraction pattern at the wave guide output.

FIG. 10 gives a possible embodiment example with graded index lens parameters that are achievable through the planar structure ion exchange technique, which will be described below.

The characteristics of the interconnection zone are as follows for a carried light beam wavelength of 1.55 μm:
depth of burial of the input guide, X_{oG}=15 μm;
radius of the “waist” of the bound mode 5 μm;
refractive index of the glass substrate 1.52;
maximum index variation of the first lens 0.08;
depth of burial of the first lens 20 μm;
radius of the first lens 20 μm;
length of the first lens 90 μm;
maximum index variation of the second lens 0.03;
depth of burial of the second lens 25 μm;
radius of the second lens 100 μm;
length of the second lens 800 μm.

The result of these characteristics is that the depth of burial X_{FC} of the collimated beam (of the axis of the beam relative to the surface of the substrate) is 66 μm and that the width of the collimated beam ΔX_{FC} is 63.9 μm.

FIG. 11 gives a second embodiment example of an interconnection zone for a photonic integrated circuit according to the invention. As for the first embodiment, the substrate is seen in cross-section along the plane XOZ. The line 85 shows the surface of the substrate. Also shown is the optical wave guide 84 one end of which is facing the interconnection zone 82 constituted by a first lens 182 and by a second lens 282.

As for the previous figure a diagram of axes OZ and OX is superposed on the cross-section of the substrate. The origins of the axes are the same as previously.

The image point given by the first lens 182 coincides with the input surface of the second lens 282.

FIG. 11 gives a possible embodiment example with graded index lens parameters that can be implemented by the planar structure ion exchange technique.

The characteristics of the interconnection zone are as follows for a carried light beam wavelength of 1.55 μm:
depth of burial of the input guide, X_{G}=15 μm;
radius of the “waist” of the bound mode 5 μm;
refractive index of the glass substrate 1.52;
maximum index variation of the first lens 0.08;
depth of burial of the first lens 20 μm;
radius of the first lens 20 μm;
length of the first lens 90 μm;
maximum index variation of the second lens 0.03;
depth of burial of the second lens 25 μm;
radius of the second lens 150 μm;
length of the second lens 1200 μm.

The result of these characteristics is that the depth of burial X_{FC} of the collimated beam (of the axis of the beam relative to the surface of the substrate) is 86.5 μm and that the width of the collimated beam ΔX_{FC} is 95.8 μm.

From these examples it appears that collimated beams of diameter greater than 90 μm are easily achievable for coupling element integration zone lengths of the order of 1500 μm that are perfectly compatible with the dimension requirements of opto-electronic devices. Considerably more substantial beam diameters are conceivable if required through various modifications of the parameters of the optical system.

FIGS. 12, 13 and 14 give other possible embodiment examples of interconnection zones that provide not a collimation of the object point (infinite image) but an image at a finite distance from the object.

FIG. 12 therefore gives a third embodiment example of an interconnection zone. As with the two previous embodiment examples, the substrate is seen in cross-section along the plane XOZ. The dot and dash line 95 shows the surface of the substrate. Also shown is the optical wave guide 94 one end of which is facing the interconnection zone 92 constituted by a first lens 192 and by a second lens 292.

As previously, a diagram of axes OZ and OX is superposed on the cross-section of the substrate. The origins of the axes are the same as previously.

The characteristics of the interconnection zone are as follows for a carried light beam wavelength of 1.55 μm:
depth of burial of the input guide, X_{oG}=15 μm;
radius of the “waist” of the bound mode 5 μm;
refractive index of the glass substrate 1.52;
maximum index variation of the first lens 0.08;
depth of burial of the first lens 20 μm;
radius of the first lens 20 μm;
length of the first lens 100 μm;
maximum index variation of the second lens 0.08;
depth of burial of the second lens 30 μm;
radius of the second lens 20 μm;
length of the second lens 100 μm.

FIG. 13 gives a fourth embodiment example of an interconnection zone. As with the three previous embodiment examples, the substrate is seen in cross-section along the plane XOZ. The dot and dash line 105 shows the surface of the substrate. Also shown is the optical wave guide 104, one end of which is facing the interconnection zone 102 constituted by a first lens 202 by a second lens 302.

As previously, a diagram of axes OZ and OX is superposed on the cross-section of the substrate. The origins of the axes are the same as previously.

The characteristics of the interconnection zone are as follows for a carried light beam wavelength of 1.55 μm:
depth of burial of the input guide, X_{oG}=15 μm;
radius of the “waist” of the bound mode 5 μm;
refractive index of the glass substrate 1.52;
maximum index variation of the first lens 0.08;
depth of burial of the first lens 20 μm;
radius of the first lens 20 μm;
length of the first lens 100 μm;
maximum index variation of the second lens 0.08;
depth of burial of the second lens 30 μm;
radius of the second lens 20 μm;
length of the second lens 100 μm.

FIG. 14 therefore gives a fifth embodiment example of an interconnection zone. As with the four previous embodiment examples, the substrate is seen in cross-section along the plane XOZ. The dot and dash line 115 shows the surface of the substrate. Also shown is the optical wave guide 114 one end of which is facing the interconnection zone 112 constituted by a first lens 212 and by a second lens 312.

As previously, a diagram of axes OZ and OX is superposed on the cross-section of the substrate. The origins of the axes are the same as previously.

The characteristics of the interconnection zone are as follows for a carried light beam wavelength of 1.55 μm:
depth of burial of the input guide, X_{oG}=15 μm;
radius of the “waist” of the bound mode 5 μm;
refractive index of the glass substrate 1.52;
maximum index variation of the first lens 0.08;
depth of burial of the first lens 20 μm;
radius of the first lens 20 μm;
length of the first lens 100 μm;
maximum index variation of the second lens 0.08;
depth of burial of the second lens 30 μm;
radius of the second lens 50 μm;
length of the second lens 200 μm.

The result of these characteristics is that the depth of burial X_{FC} of the collimated beam (of the axis of the beam relative to the surface of the substrate) is 86.5 μm and that the width of the collimated beam ΔX_{FC} is 95.8 μm.

The simulations shown in FIGS. 12 and 13 show particular advantageous cases in which the angular axis of symmetry of the image beam remains parallel to the surface plane. This configuration is obtained by a judicious choice of the parameters of the optical system formed by the two lenses constituting the interconnection zone and in particular the position of the axes of the lenses relative to the axis of the wave guide. It can also be seen, by comparing FIGS. 12, 13 and 14, that the angular aperture of the image light beam may be easily adapted as a function of the parameters of the two lenses employed and in particular of the lengths and distances between the lenses. It is therefore possible, by a judicious choice of parameters, to achieve the optimum angular aperture in order to obtain an optimum energy coupling with a component located outside the integrated optical chip (optical fibre, another light guide, etc).

All these different examples are only illustrative of the possibilities afforded by the invention. It is possible to implement by means of the approach proposed by the invention all the configurations given by known optical systems comprising one, two or more graded index lenses and suitably selected optical and geometric parameters.

FIGS. 8 to 14 show cross-section views of the lenses and therefore the optical imaging patterns in the cross-section plane XOZ.

When seen from above, as already shown in FIGS. 3 and 5, the lenses will also have to have the necessary imaging properties. The optical parameters along these planes parallel to the surface plane YOZ will be deduced from the corresponding refractive index profiles.

All the optical structures presented must therefore be seen as structures with two symmetrical or non-symmetrical dimensions.

It is moreover possible to play with these dissymetries in order to modify the geometric shape of the light beams between the object and image planes and to obtain far-field diffraction patterns in the image plane better adapted to an optimum energy coupling between two guided optical components or between one guided optical component and one free space optical component. This type of property may for example be used in order to optimise the coupling between a laser diode emitting a very astigmatic light beam and a symmetrical light guide, the bound mode of which is for example very close to that of an optical fibre.

An extreme case is also provided by cylindrical lenses, for which the index profiles will be invariant along the planes parallel to the plane YOZ.

Controlling the refractive index profiles Δnᵢ (x,y) or possibly Δnᵢ (x,y,z), for example in the case of lenses with convex input or output surfaces, allowing imaging properties to be obtained that are required for each graded index lens constituting the optical system, is one of the points of the invention that should be fully apprehended.

A detailed description will now be given of the way to implement the interconnection zones.

Traditionally, commercially available graded index lenses have parabolic refractive index profiles of circular symmetry since the ion exchange between the exchange bath and the glass cylinder used occurs in perfect conditions of symmetry. This is clearly no longer possible in the case of the invention for which the refractive index profiles must of necessity be implemented from the surface of a substrate (or wafer). In this case, the index profiles to be achieved, which must be approximately parabolic in shape as a function of the distance rᵢ to the axis so as to obtain the required optical imaging properties, require a sequence of original steps which constitute another aspect of the invention.

FIG. 15 shows a cylindrical element 120 able to provide a lens of circular symmetry. For this type of element, the index profiles to be implemented must be, at the level of each cross-section plane Pᵢ, perpendicular to the axis of the lens and of the form:
Δnᵢ(xᵢ,yᵢ)=Δnᵢ(rᵢ)=n₀ᵢ*sech(gᵢrᵢ)#n₀ᵢ*(1−gᵢ²rᵢ²/2)

with rᵢ=(xᵢ²+yᵢ²)^{1/2}, gᵢ[8(Δnᵢ(0)−Δnᵢ(r₀ᵢ))/r₀ᵢ²]^{0.5} and r₀ᵢ is the radius of the lens.

In this formula the axes of the coordinates are OᵢXᵢ, OᵢYᵢ and OᵢZᵢ (OᵢXᵢ perpendicular to the surface plane of the wafer, OᵢYᵢ and parallel to this surface plane, the plane OᵢXᵢYᵢ being perpendicular to the axis of the lens 0zᵢ).

The parameter gᵢ depends on the variation in refractive index between the centre and the edge of the lens and on the maximum radius r₀ᵢ of the lens. The value of gᵢ determines, inter alia, the focal length fᵢ and the frontal length sᵢ (distance between the focal object point and the input surface of the lens) of the lens Lᵢ considered with:
fᵢ=l/n₀ᵢ*gᵢ*sin(gᵢlᵢ)sᵢ=l/n₀ᵢ*gᵢ*tg(gᵢlᵢ)

lᵢ being the length of the lens assumed, in order to simplify the presentation and the mathematical formulae, to have plane input and output surfaces.

It needs to be remembered however that the results of the invention apply to lenses whose input and output surfaces are for example convex.

Obtaining the profiles Δnᵢ(rᵢ) required at the level of the imaging elements relies on the following technological approach which comprises at least three stages.

A first stage consists of an ion exchange through a mask comprising the appropriate geometric shapes as a function of the ions A and the ions B contained in the substrate. This ion exchange is for example obtained by hardening the glass wafer fitted with a mask of suitable geometric shape in a bath at a temperature Tᵢ containing ions A and for a time tᵢ by applying to advantage an electric field between the surface of the substrate on which the mask is deposited and the opposite surface. This operation allows a first refractive index profile to be obtained over a depth dᵢ.

A second stage consists in rediffusing ions A in the substrate by applying to further advantage an electric field between the surface of the substrate on which the mask is deposited and the opposite surface. This ion exchange is for example obtained by hardening the wafer in the bath at a temperature T₂ containing ions B and for a time t₂ by applying to advantage an electric field between the surface of the substrate on which the mask is deposited and the opposite surface. This operation leads to the burying of the previous index profile over an average depth d₂.

A third stage consists of a thermal rediffusion at a temperature T₃ and for a time t₃ with no electric field being applied. Depending on the specifications required, this operation may take place in a bath containing ions B or simply in a controlled atmosphere.

FIG. 16 shows a refractive index profile form close to the profiles that are to be desired and obtained with the following operational parameters:
the ions A are silver ions A_{g}⁺,
the ions B are sodium ions Nₐ⁺,
the temperature Tᵢ is about 330° C. and the time tᵢ is about 22 minutes,
the temperature T₂ is about 260° C. and the time t₂ is about 80 minutes,
the temperature T₃ is about 330° C. and the time t₃ is about 1200 minutes.

Δn represents the standardised index variation.

The mask used may have a rectangular aperture of width of the order of eᵢ=15 μm and of length l′ᵢ corresponding to the functionality required (collimation or finite distance imaging). The material used for the local masking of ion exchanges may be of a different type. Among the most common masks may be mentioned aluminium, aluminium oxide, silicon, titanium or nickel but other materials might also be suitable.

Typically and given the maximum index variations Δnᵢ (xᵢ,yᵢ) that are accessible through the fabrication method previously described of between 0.01 and 0.07 and the achievable lens radii of between 15 and 300 μm, the length lᵢ may vary from a few tens of micrometres to a few millimetres taking into account the focal lengths and imaging architectures required.

The electrical voltage V applied during the exchanges under field may be approximately 325 volts.

Possibly, it may be necessary in respect of some configurations of optical elements to introduce an additional stage between the first and the second stage described above. This additional stage consists of a thermal rediffusion at a temperature T′₁ and for a time t′₁. This rediffusion is for example obtained by hardening the wafer in a bath at a temperature T′₁ containing ions B and for a time t′₁ with no electric field being applied.

To obtain a lens Lᵢ of length lᵢ, and of radius r₀ᵢ like the one shown diagrammatically in FIG. 16, the mask used must have dimensions close to a rectangular aperture of length l′ᵢ and of width eᵢ.

The values of l′ᵢ and eᵢ depend of course on the exchange and diffusion parameters selected for the different stages of fabrication.

In the practical example given previously it may be seen that for an aperture eᵢ of the order of 15 μm, the radius r₀ᵢ of the lens obtained is of the order of 110 μm.

As for the length l′ᵢ, this can be deduced from the length lᵢ required by taking account of the axial expansion caused by the ion exchange and the thermal diffusions.

In practice, l′ᵢ will be selected to be less than lᵢ. It must be kept in mind however that if a rectangular shape of the mask is the simplest to be able to be implemented, slightly different geometries may present different advantages as a function of the imaging performances required.

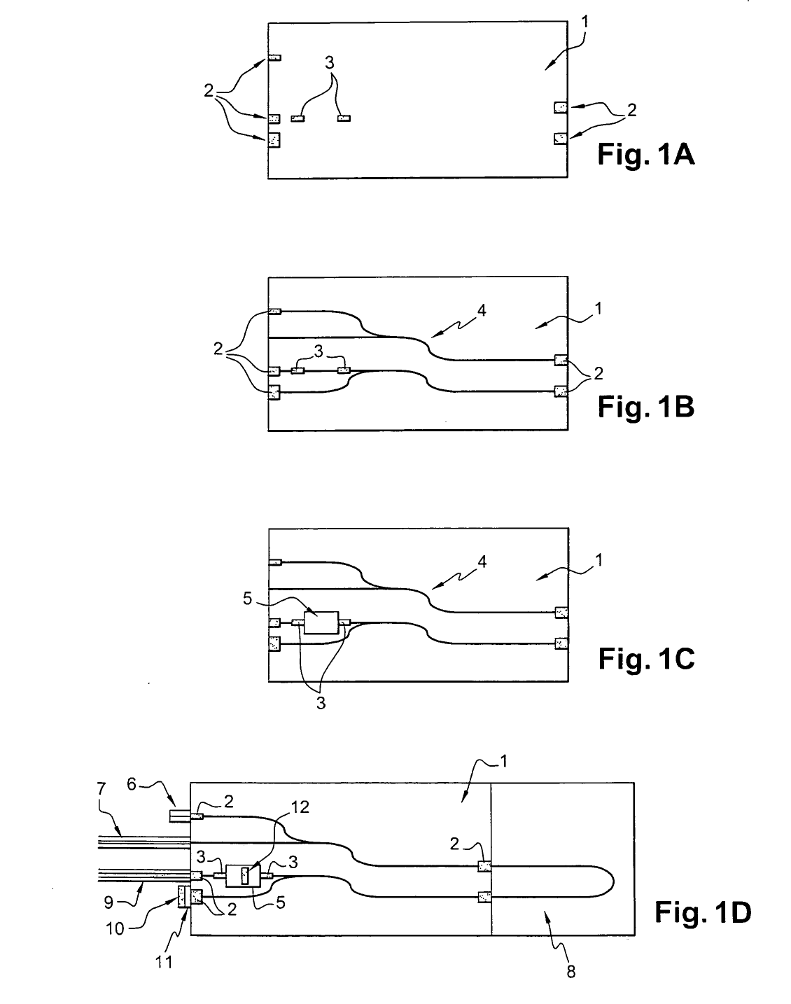

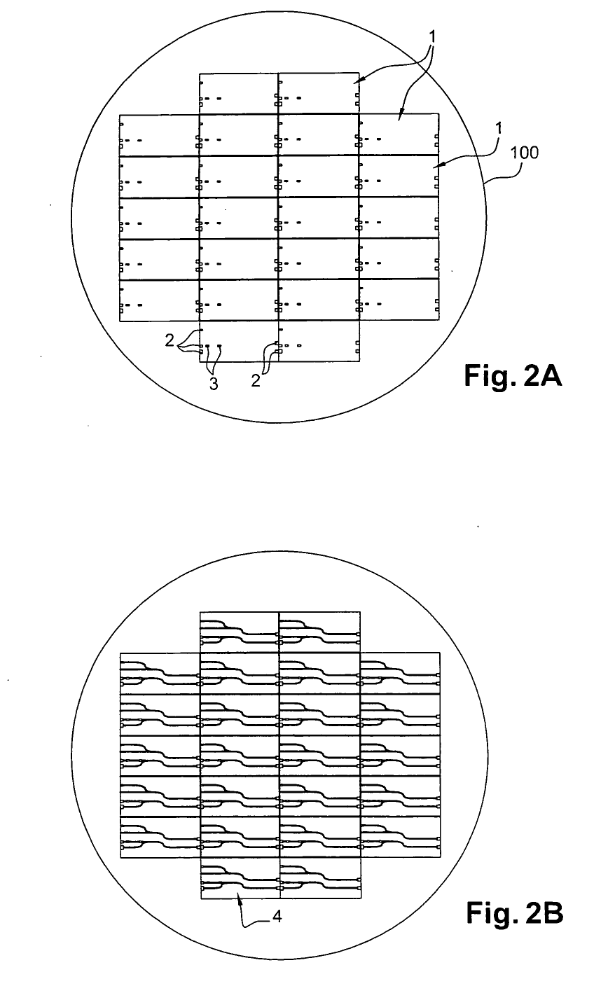

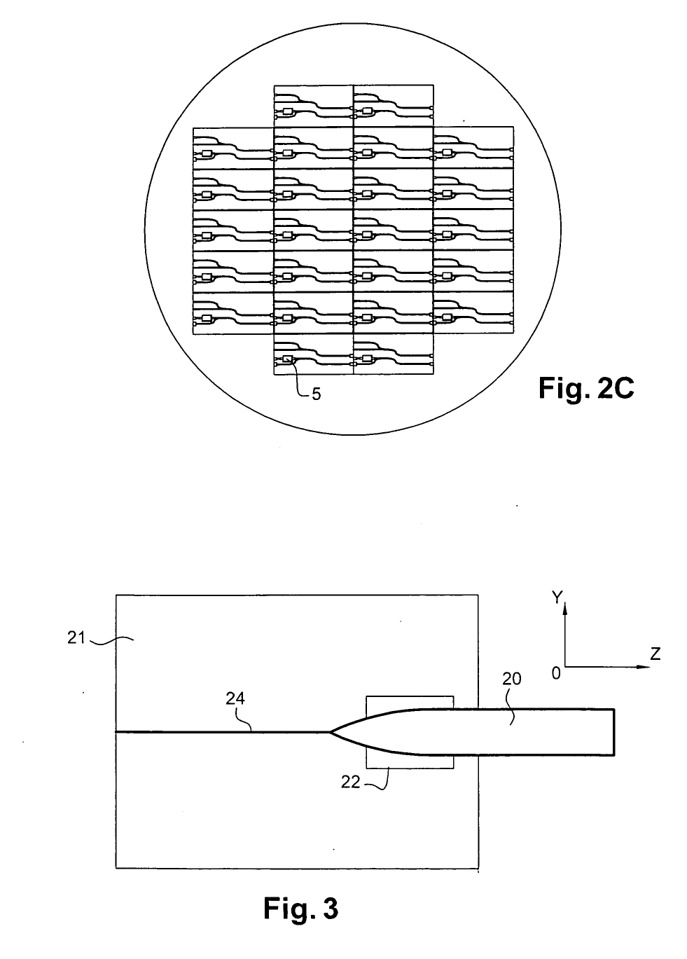

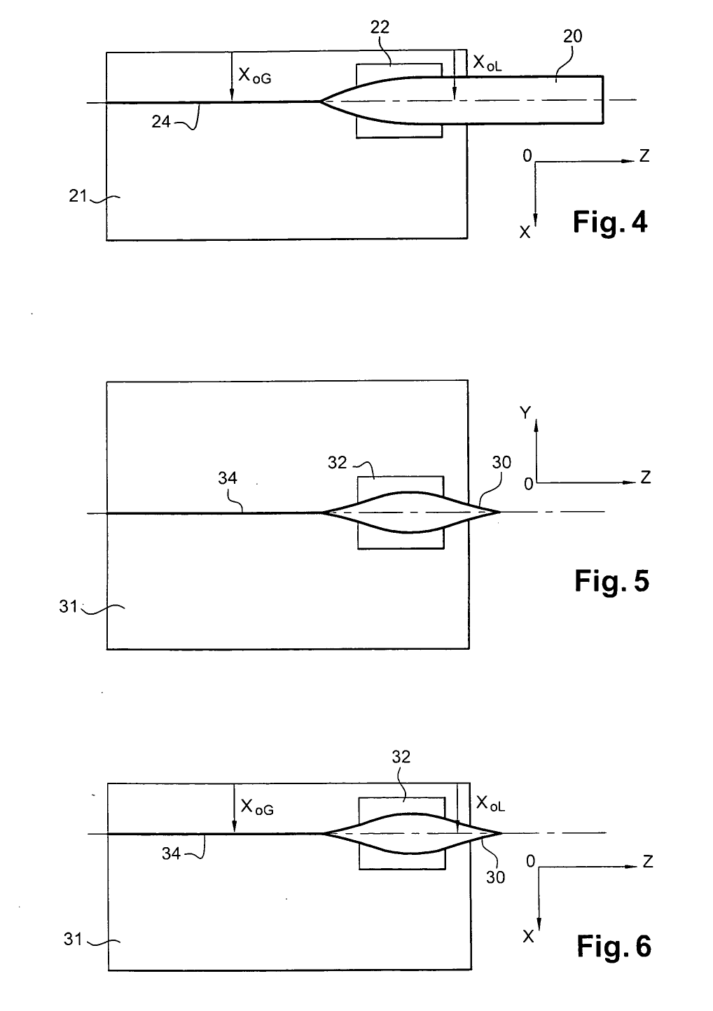

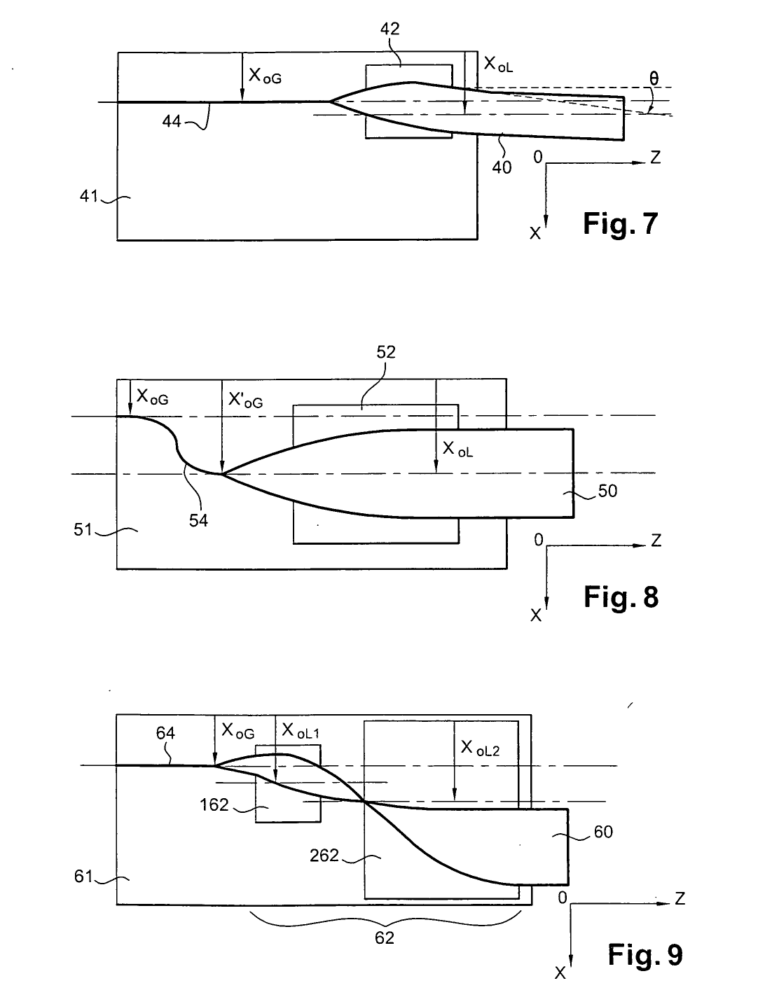

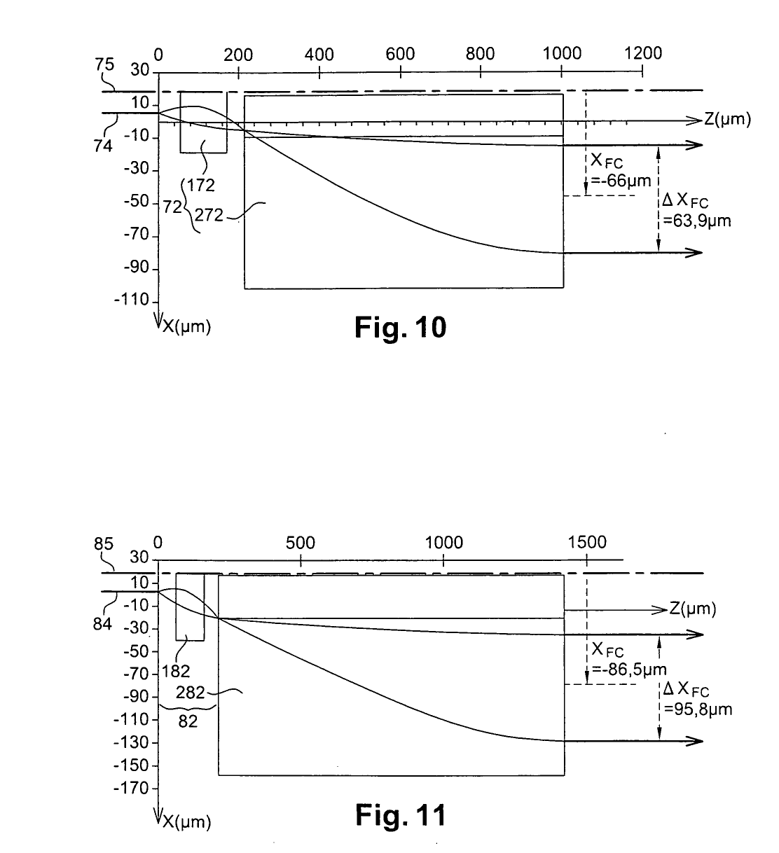

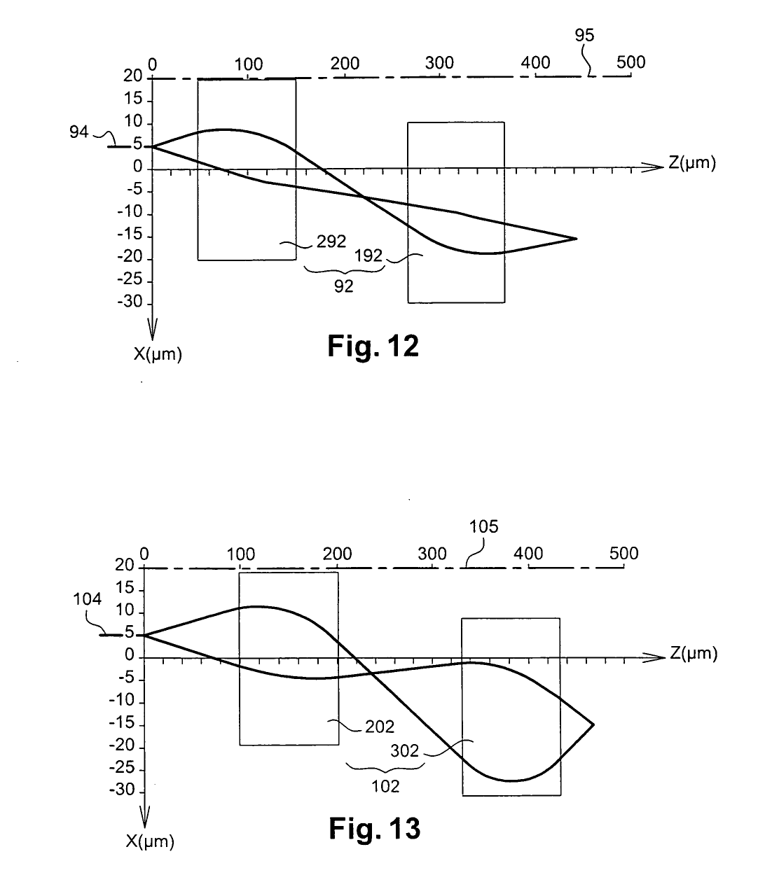

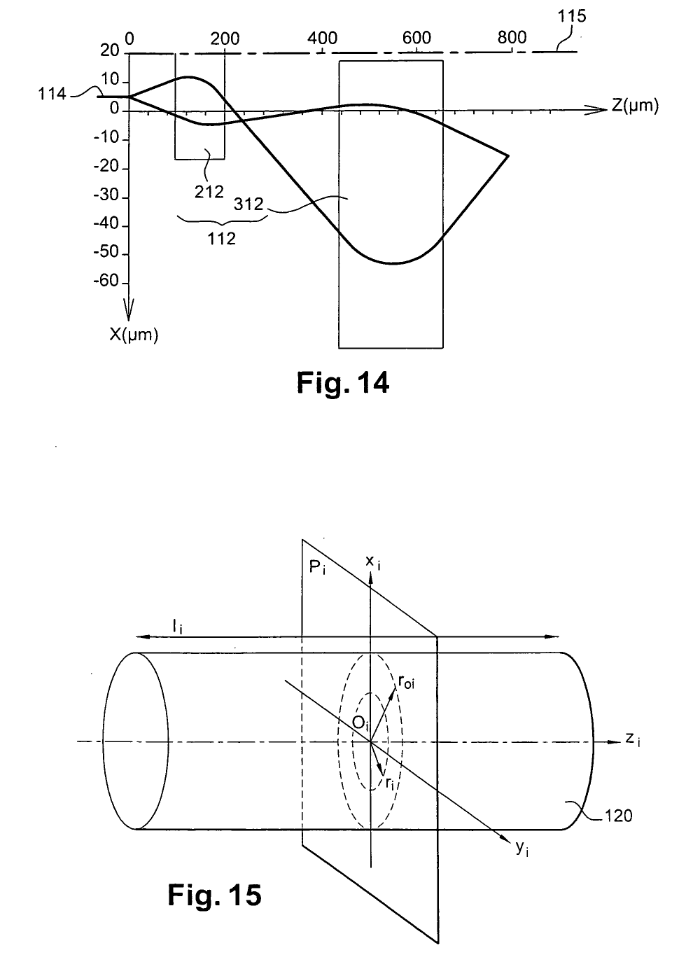

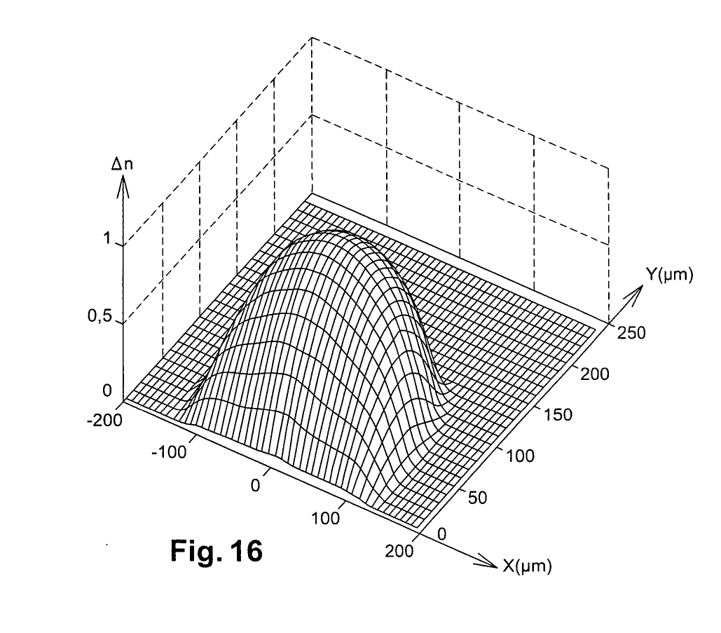

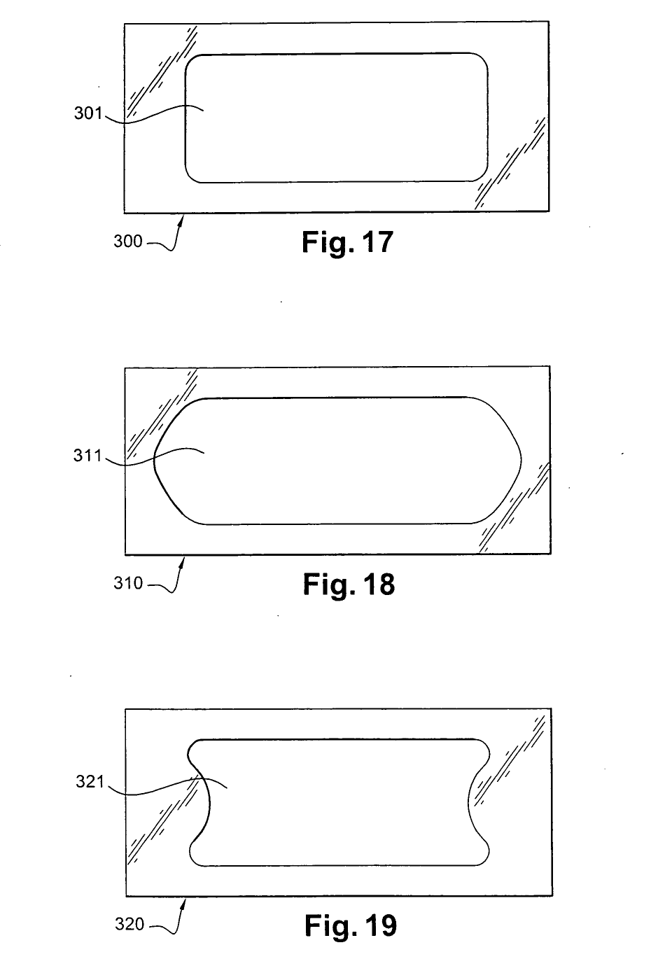

FIGS. 17 to 24 showed different configurations of masks that can be used to implement the present invention.

Geometric mask shapes like the one shown in FIG. 17 for example may be used to compensate for fringe effects that are too pronounced. In this figure, the mask 300 is provided with a rectangular aperture 301, two adjacent sides of the aperture being connected by a neck moulding.

Likewise, the diffusion phenomena employed during the different stages will naturally lead to lenses that have convex input and output surfaces. The associated curve can then be accentuated or conversely reduced, or even reversed, by using masks of an adapted geometric shape. In this way, FIG. 18 shows a mask 310 that has an adapted aperture 311 and FIG. 19 shows a mask 320 that has an adapted aperture 321.

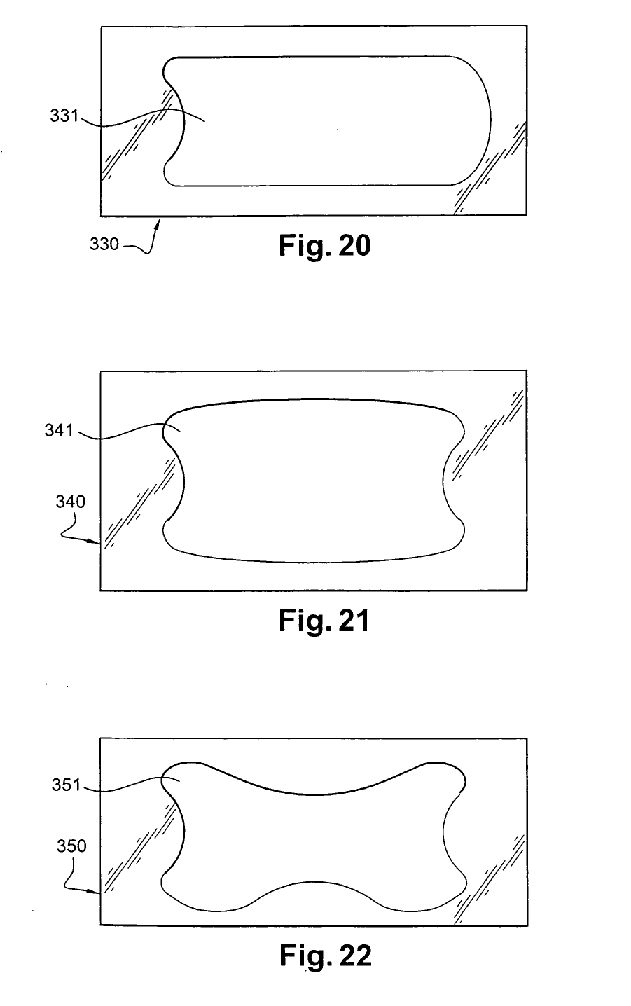

Clearly, intermediate shapes with input surface and output surface having different curves may be implemented through a combination of the geometric shapes described. This is what is shown in FIG. 20, which shows a mask 330 that has an aperture 331 of non-symmetrical shape.

Furthermore, the sides of the masks are able not to be rectilinear as shown previously in order to implement non-constant index profiles along the axis of the Zs and to be able to modify the imaging properties of the components. By this method, it is in particular possible to modify the value of the aberrations of the optical component so embodied and to take advantage of the flexibility offered by the simple modification of the geometric shape of the mask. Possible shapes are shown in FIG. 21 where the mask 340 is provided with the aperture 341 and by FIG. 22 where the mask 350 is provided with the aperture 251.

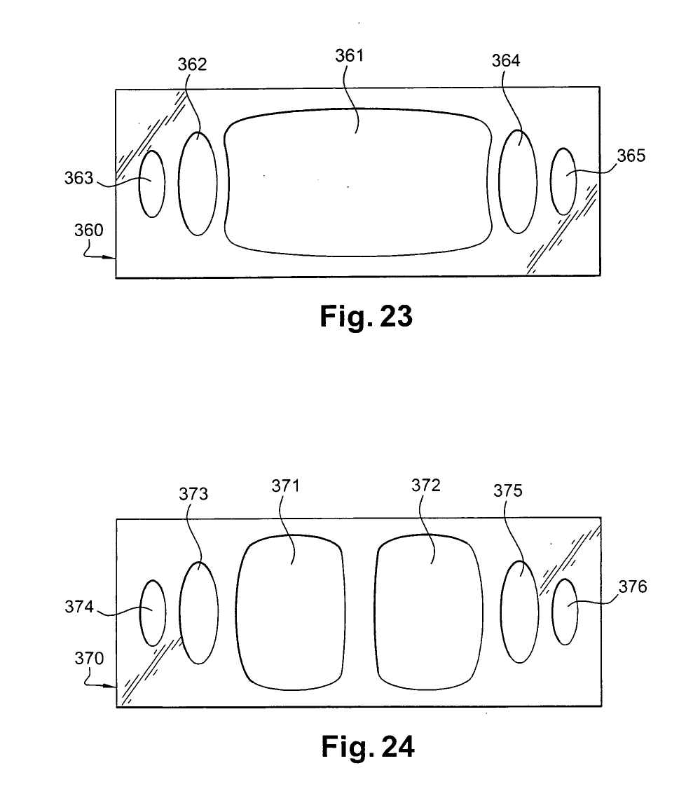

It is still possible to use segmented masks to obtain rougher modifications of the index profiles and to take advantage of certain fringe effects. FIGS. 23 and 24 give possible examples of such geometries. FIG. 23 shows a mask 360 that has a principal central aperture 361, secondary lateral apertures 362 and 363 on one and the same side of the central aperture and secondary lateral apertures 364 and 365 on another side (opposite the previous one) of the central aperture. FIG. 24 shows a mask 370 that has central apertures 371 and 372, secondary lateral apertures 373 and 374 on one and the same side relative to the central apertures and secondary lateral apertures 375 and 376 on another side (opposite to the previous one) relative to the central apertures.

Clearly, in the case of an optical system comprising several lenses and depending in particular on the depths of burial of each of the components, it may be necessary to separate the implementation stages of the different elements of the system if the exchange and diffusion parameters are very different. In this case the elements that are the most extensive in depth and will be made first and in order of extension. The duration period of exchanges and diffusion will then be calculated for each element implemented taking into account previous and the subsequent operations.

1-17. (canceled)

18. A photonic integrated circuit comprising:
a substrate comprising at least one optical circuit; and
an interface for interconnecting the optical circuit with at least one opto-electronic component added to the substrate, the interface comprising at least one zone of said substrate with the refractive index thereof being modified to provide said interface, said zone of the substrate including at least one graded index lens.

19. A photonic integrated circuit according to claim 18, wherein said zone of the substrate includes at least two graded index lenses, the axes of which are offset one relative to the other.

20. A photonic integrated circuit according to claim 18, wherein the optical circuit is a circuit manufactured by an ion exchange technique.

21. A photonic integrated circuit according to claim 18, wherein said substrate zone is a zone manufactured by an ion exchange technique.

22. A photonic integrated circuit according to claim 18, wherein the optical circuit comprises an optical wave guide, one end of which is located facing said zone of the substrate so as to make an optical connection with said zone of the substrate.

23. A photonic integrated circuit according to claim 18, wherein said zone of the substrate is located in the substrate so as to be facing an input or an output of the opto-electronic component so as to make an optical connection with said opto-electronic component.

24. A photonic integrated circuit according to claim 18, wherein the opto-electronic component is located proximate a periphery of the substrate.

25. A photonic integrated circuit according to claim 18, wherein the opto-electronic component is located on a surface of the substrate.

26. A photonic integrated circuit according to claim 25, wherein the substrate comprises at least one cavity allowing at least one opto-electronic component to be accommodated.

27. A photonic integrated circuit according to claim 25, wherein the substrate comprises at least one cavity allowing at least one optical component to be accommodated.

28. A process for making photonic integrated circuits comprising:
providing a substrate;
manufacturing, on the wafer, an optical circuit element;
manufacturing, on the wafer, an interface, including a graded-index lens, for each photonic integrated circuit in a respective zone of the substrate, by modifying a refractive index of the substrate within the zone;
manufacturing on the wafer at least one opto-electronic component in communication with the optical circuit element via the interface; and
dicing the wafer to obtain the respective photonic integrated circuits.

29. A process as in claim 28, further comprising, manufacturing, on the wafer, a structure for accommodating at least one opto-electronic and/or optical component for each photonic integrated circuit.

30. A process as in claim 28, further comprising adding at least one opto-electronic component and/or at least one optical component to complete the photonic integrated circuits.

31. A process according to claim 28, further comprising, using a mask that has a principal aperture that is overall rectangular in shape and adjacent sides connected by a neck molding for manufacturing the interface.

32. A process according to claim 31, wherein the aperture has two opposite sides that are convex in shape and the other two opposite sides concave in shape.

33. A process according to claim 31, wherein the aperture has two opposite sides that are convex and/or concave in shape.

34. A process according to claim 31, wherein the aperture has all its sides convex or concave in shape.

35. A process according to claim 31, wherein the mask also has at least one secondary aperture located near to at least one side of the principal aperture.
